(19) United States
(12) Patent Application Publication
(10) Pub. No.: US 2025/0225692 A1
(43) Pub. Date: Jul. 10, 2025

(54) METHODS AND SYSTEMS FOR GENERATING COLORIZED ORGANOID IMAGES

(71) Applicant: UNIVERSITY OF NORTH TEXAS, Dallas, TX (US)

(72) Inventors: Huaxiao YANG, Dallas, TX (US); Yunhe FENG, Dallas, TX (US); Arun Kumar Reddy KANDULA, Dallas, TX (US)

(21) Appl. No.: 19/006,685

(22) Filed: Dec. 31, 2024

Related U.S. Application Data
(60) Provisional application No. 63/618,181, filed on Jan. 5, 2024.

(51) Int. Cl. G06T 11/00; G06T 7/90; G06V 10/764; G06V 10/82

(52) U.S. Cl. CPC G06T 11/001; G06T 7/90; G06V 10/764; G06V 10/82; G06T 2207/10024; G06T 2207/20072; G06T 2207/20084; G06T 2207/30004; G06T 2210/41; G06V 2201/031

(57) ABSTRACT

In some embodiments, a method for generating colorized organoid images comprises synthesizing, by a generator, an input feature map from a grayscale image derived from a lightness channel as a conditional input; extracting, by a convolution block attention layer (CBAL); and generating, by the CBAL, a refined output feature map derived from a 1D channel attention map and a 2D spatial attention map. The method further comprises synthesizing, by the generator, color information derived from the lightness channel and the refined output feature map, calculating, by a discriminator based on at least the lightness channel and the color information, a value indicating a probability that the color information is real; and performing the aforementioned steps iteratively until the generator produces the color information which the discriminators can no longer identify as fake.

### CROSS-REFERENCE TO RELATED APPLICATIONS

This application claims the benefit of U.S. Provisional Application No. 63/618,181, filed on Jan. 5, 2024, and entitled “GENERATIVE AI FOR CARDIAC ORGANOID IMAGE COLORIZATION,” which is incorporated herein by reference in its entirety for all purposes.

### STATEMENT REGARDING FEDERALLY FUNDED RESEARCH OR DEVELOPMENT

None.

### BACKGROUND

Various human organ-specific organoids, including recent cardiac organoids, have been developed and employed in cardiovascular disease modeling and drug screening. An organ-specific organoid is a miniaturized, simplified, three-dimensional tissue model that can be grown in vitro from stem cells that mimics the structure and function of a specific human organ. These organoids are used extensively in medical research to study human development, disease mechanisms, and drug responses. To comprehend organoid differentiation and structure, microscopic imaging becomes relevant with both phase contrast and fluorescence. In in the past, a triple reporter human pluripotent stem cells (hPSC) line (3R) was created with three fluorescence reporters for labeling three different types of cardiovascular cells. Upon hPSC differentiation into vascularized cardiac organoids (VCOs), three relevant cardiovascular cells can be visualized by live-cell imaging: green (Green Fluorescent Protein—GFP) representing cardiomyocytes (CMs), red/orange (Red Fluorescent Protein/Monomeric Orange Protein—RFP/mOr) representing endothelial cells (ECs), and blue (Cyan Fluorescent Protein—CFP) representing smooth muscle cells (SMCs). Because each fluorescence signal corresponds to a specific cell type and corresponding cellular network, this 3R hPSC line has been helpful in tracking cardiac organoid formation in a temporospatial manner for potential applications of disease modeling and drug screening. However, it holds a very obvious limitation, only one cell line is utilized and enabled to visualize the colorful cardiovascular cells in the hPSC-derived cardiac organoids. A diverse and large number of hPSC lines are typically required for achieving more generalized outcomes from biomedical applications. While phase contrast microscopic imaging is routinely applied and conveniently used in many biomedical labs for organoid examination, generating accurate fluorescence information or image colorization on phase contrast images of cardiac organoids would potentially broaden the characterization and analysis of hPSC-derived cardiac organoids in a high-throughput and time-efficient manner.

### SUMMARY

In some embodiments, a method for generating colorized organoid images comprises synthesizing, by a generator, an input feature map from a grayscale image derived from a lightness channel as a conditional input; extracting, by a convolution block attention layer (CBAL), a 1D channel attention map and a 2D spatial attention map derived from the input feature map; and generating, by the CBAL, a refined output feature map derived from the 1D channel attention map and the 2D spatial attention map. The method further comprises synthesizing, by the generator, color information derived from the lightness channel and the refined output feature map, wherein the color information comprises an a* channel and a b* channel; calculating, by a discriminator based on at least the lightness channel and the color information, a value indicating a probability that the color information is real; and performing the aforementioned steps iteratively until the generator produces the color information which the discriminators can no longer identify as fake.

In some embodiments, a method for generating colorized organoid images comprises synthesizing, by a patch generator, an input feature map from a grayscale image derived from a lightness channel as a conditional input; extracting, by a convolution block attention layer (CBAL), one or more patches of a 1D channel attention map and a 2D spatial attention map derived from the input feature map; and generating, by the CBAL, the one or more patches of a refined output feature map derived from the 1D channel attention map and the 2D spatial attention map. The method further comprises synthesizing, by the generator, the one or more patches of color information derived from the lightness channel and the refined output feature map, wherein the color information comprises an a* channel and a b* channel; calculating, by a discriminator based on at least the lightness channel and the color information, a value indicating a probability that the color information is real; and the generator and the discriminator performing the aforementioned steps iteratively until the generator produces the color information which the discriminators can no longer identify as fake for the one or more patches.

In some embodiments, a system for capturing fluorescence intricacies of cardiovascular cells (CMs, ECs, and SMCs) in hPSC-derived cardiac organoids, comprises a generator for synthesizing an input feature map from a grayscale image derived from a lightness channel as a conditional input; a convolution block attention layer (CBAL) for extracting a 1D channel attention map and a 2D spatial attention map derived from the input feature map, and generating a refined output feature map derived from the 1D channel attention map and the 2D spatial attention map; and the generator for synthesizing by color information derived from the lightness channel and the refined output feature map, wherein the color information comprises an a* channel and a b* channel. The system further comprises a discriminator calculating based on at least the lightness channel and the color information, a value indicating a probability that the color information is real; and the generator and the discriminator performing the aforementioned steps iteratively until the generator produces the color information which the discriminators can no longer identify as fake.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description:

FIG. 1 is a schematic depiction of an embodiment of a GAN architecture overview of fluorescence colorization of hPSC-derived cardiac organoids.

FIG. 2 is a pictorial depiction of an embodiment of (a) an image divided into 8×8 grid of small patches, (b) highlighted in red is the ROI, which is given more weightage for histogram comparison. The image size is 256×256, which breaks into a 16×16 grid with multiple patches of size at 32×32 pixels with a scale bar of 2 millimeter (mm).

FIG. 3 is a pictorial depiction of an embodiment of (a) images of hPSC-derived cardiac organoids from input, ground truth, and predicted images generated by Model 1, Model 2, and Model 3 respectively. Cardiac organoids being hPSC-derived are not included in the training dataset but from the same batch of experiments with a scale bar of 2 mm, and (b) a tabular depiction of evaluation scores by three different evaluation metrics.

FIG. 4 is a pictorial depiction of an embodiment of (a) images of hPSC-derived cardiac organoids from input, ground truth, and predicted images generated by Model 1, Model 2, and Model 3 respectively. Cardiac organoids being hPSC-derived are from different batches of experiments with a scale bar of 2 mm, and (b) a tabular depiction of evaluation scores on new batches of organoids.

FIG. 5 is a pictorial depiction of an embodiment of (a) images of hPSC-derived cardiac organoids after fine tuning from input, ground truth, and Model 2 of hPSC-derived cardiac organoids from different batches of experiments with a scale bar of 2 mm, and (b) a tabular depiction of an evaluation score on new batches of organoids after fine tuning.

FIG. 6 is a schematic depiction of an embodiment of a U-Net generator architecture with Convolutional Block Attention Module (CBAM) or Convolutional Block Attention Layer (CBAL) overview.

FIG. 7 is a schematic depiction of an embodiment of a CBAM overview.

FIG. 8 is a schematic depiction of an embodiment of a patch discriminator architecture.

FIG. 9 is a depiction of data for embodiments of quantification and comparison of the individual fluorescence channels in ground truth and predicted images of hPSC-derived cardiac organoids of the same batch of differentiation formatted in Table 1. Green blocks show low difference percent less than 25 percent and red blocks show high difference percent more than 25 percent.

FIG. 10 is a depiction of data for embodiments of quantification and comparison of the individual fluorescence channels in the ground truth and predicted images of hPSC-derived cardiac organoids of a new batch of differentiation formatted in Table 2. Green blocks show low difference percent less than 25 percent and red blocks show high difference percent more than 25 percent.

FIG. 11 is a depiction of data for embodiments of a summary of the quantification and comparison of the individual fluorescence channels in the ground truth and predicted images of hPSC-derived cardiac organoids on a new batch of organoid differentiation. Green blocks show low difference percent less than 25 percent and red blocks show high difference percent more than 25 percent.

### DETAILED DESCRIPTION

As used herein, the term “and/or” can mean one or more of items in any combination in a list, such as “A and/or B” means “A, B, or the combination of A and B”.

As used here, a “generator module” may be used interchangeably with “a generator”; a “discriminator module” may be used interchangeably with a “discriminator”, and a “convolution block attention module” (CBAM) may be used interchangeably with a “convolution block attention layer” (CBAL).

Human pluripotent stem cell (hPSC)-derived cardiac organoid is the most recent three-dimensional tissue structure that mimics the structure and functionality of the human heart and plays a pivotal role in modeling heart development and disease. The hPSC-derived cardiac organoids are commonly characterized by bright-field microscopic imaging for tracking daily organoid differentiation and morphology formation. Although the brightfield microscope provides essential information about hPSC-derived cardiac organoids, such as morphology, size, and general structure, it does not extend understanding of cardiac organoids on cell type-specific distribution and structure. Typically, fluorescence microscopic imaging is required to identify the specific cardiovascular cell types in the hPSC-derived cardiac organoids by fluorescence immunostaining fixed organoid samples or fluorescence reporter imaging of live organoids. Both approaches require extra steps of experiments and techniques and do not provide general information on hPSC-derived cardiac organoids from different batches of differentiation and characterization, which limits the biomedical applications of hPSC-derived cardiac organoids. This limitation can be addressed by proposing a comprehensive workflow for colorizing phase contrast images of cardiac organoids from brightfield microscopic imaging using conditional generative adversarial networks (GANs) to provide cardiovascular cell type-specific information in hPSC-derived cardiac organoids. By infusing these phase contrast images with accurate fluorescence colorization, the approach aims to unlock the hidden wealth of cell type, structure, and further quantifications of fluorescence intensity and area, for better characterizing hPSC-derived cardiac organoids.

Numerous approaches have been explored to tackle the challenge of image colorization by artificial intelligence (AI). Traditional machine learning (ML) techniques extract similar features from a reference image to predict colors in a new image, while the efficacy of such methods is contingent on the similarity between the reference image and the target. The advent of convolutional neural networks (CNNs) marked a shift, allowing for the automatic extraction of features from images. Pretrained CNNs have gained prominence in image colorization, leveraging feature maps to predict pixel colors. The capabilities of generative adversarial networks (GANs) in various generative tasks have prompted their use in colorization. In this context, Conditional GANs, exemplified by Pix2Pix GAN, have emerged, mapping grayscale inputs to corresponding ground truth images. A Pix2Pix GAN, augmented with the Convolutional Block Attention Module (CBAM), can be employed enhancing the network's focus on critical features and elevating colorization realism. Despite the technological advancement of image colorization on generic image categories, there is a lack of research focused specifically on colorizing hPSC-derived tissue constructs, such as cardiac organoids. Small color discrepancies that might be tolerable for generic image generation might be detrimental to cardiac organoids' images with much smaller features. Even minor color variations in this context can introduce significant misinformation, rendering the task of organoid colorization exceptionally challenging.

Currently, there are three existing techniques for targeted image colorization, including reference image-based colorization, which is based on the color information from a reference image. In some aspects, a technique using superpixel, but the color assignment to a pixel is done by determining a candidate set of the possible colors, then the variational energy factors that enforce spatial consistency and non-local self-similarity constraints, which helped determine the most possible pixel color. This reference image-based technique can be applied in the biomedical domain. In some embodiments, the target images can be colorized using a reference-colored image, where feature mapping is done for the features extracted using SURF and Gabour filters, and image space voting based on the neighboring pixels is done to obtain the plausible pixel color. This technique may suffer at image boundaries and cause color bleeding. To solve this problem, a patch-based feature extraction and colorization technique can be used that produces more robust colors. With the breakthrough of CNN performance in image processing tasks, CNN is used widely because of its capability to automatically extract the features to find the relations between them and produce more realistic colors. In some aspects, CNN can use VGG-19 to generate feature maps based on the grayscale target and reference image. These feature maps are combined with the grayscale target image and the color information in terms ab color channels, from CIE Lab color space. This combined input can be passed to an encoder-decoder network to generate the final colored image. An architecture can be used from the visual geometry group, VGG-16, in which the first convolution layer is modified to operate on a single channel, and the classification layer may be removed. This architecture can be fine-tuned on the ImageNet dataset of gray images for one epoch. The grayscale images are passed to this modified network to generate spatially localized multicolumn layers referred to as hypercolumns, which are used to predict the color of the pixel. Multiple CNN architectures, one to extract global-level features of the image and the other to extract mid-level features, created a fusion layer that combined these two global and mid-level features now the final color predictions are generated based on the correlation of those two features. In some embodiments, an off-the-shelf VGG network and modified the loss functions can be used. The classification loss can be utilized, with rebalanced rare classes.

In this network, a CIE Lab colorspace can operate to generate a color mapping function of the corresponding (ab) channels from the input lightness (L) channel to produce state-of-the-art results. Similarly, there are many implementations of image colorization based on VGG-16 with modifications in their operating color space and the loss function. Moreover, generative adversarial network (GAN) based image colorization may also be widely used. In some aspects, Pix2Pix 14, a type of conditional GAN, becomes a popular choice for image colorization because of its ability to find information in pair-to-pair image translation. GAN network consists of or comprises a generator or a generator module, which generates the colorized image from a conditional input image, and a discriminator or a discriminator module, which tries to identify if the generated image is real or fake, GAN architecture is used to generate colored images from infrared images in RGB color space. In some aspects using three generator networks, a conditional input of the infrared image can be provided. Each generator can generate a corresponding color channel of RGB, and the combined RGB image can be passed to the discriminator network to check the probability of the generated image being real. The Pix2Pix architecture with U-Net is applied for image colorization on the CIFIAR-10 dataset, where the grayscale image can be given as the conditional input to the U-Net generator to generate a colored image, which is then passed to the discriminator to identify if the generated image is a real or fake one. In some aspects, an implemented Pix2Pix architecture can be given a grayscale image as the conditional input to the U-Net generator architecture to generate a colored image. In some embodiments, the strengths of image-to-image translation of Pix2Pix architecture can be exploited, and to increase robustness, a convolution block attention module (CBAM) can be included in the network.

In some embodiments, an image colorization of grayscale cardiac organoids using conditional generative adversarial networks (GAN), specifically a Pix2Pix model can be utilized. Generally, image colorization is a task in medical image processing, enabling a more comprehensive and intuitive visualization of grayscale images. Grayscale cardiac organoid images, acquired through various medical imaging techniques, lack color information, making it challenging for medical professionals to interpret and analyze them effectively. Employing conditional GANs, which have shown promising results in generating realistic and accurate colorizations from grayscale images, can improve analysis with a comprehensive workflow for cardiac organoid image colorization, highlighting the motivations behind using conditional GANs for this specific task. In some aspects, GANs are a class of deep learning architectures that involve two networks, a generator, and a discriminator, engaged in a competitive learning process. In the context of image colorization, the Pix2Pix model learns to map input grayscale images to corresponding colorized versions by leveraging a training dataset that contains pairs of grayscale and color images. By doing so, the model can generate plausible and realistic colorizations that align with the original context of the grayscale input. The Pix2Pix has garnered attention due to its ability to capture intricate relationships between input and output images, making it a compelling choice for various image translation tasks, including focus on cardiac organoid image colorization. Generally, this robust Pix2Pix deep-learning framework is proficient in mapping input grayscale images to their corresponding colorized versions.

Accordingly, a novel framework can be established utilizing cGANs with adversarial training between the generator and discriminator for training on organ images include cardiac organoid images (phase contrast and corresponding fluorescence images in green, red, and blue) directly differentiated from 3R, a triple-reporter hPSC line. To address the dynamic nature of cardiac organoid images, an attention mechanism, the CBAM, can be incorporated ensuring an increased emphasis on crucial details and generating more accurate colors. Through a training process on the dataset, the model can learn to intricately map grayscale cardiac organoid images (phase contrast) to the corresponding color images (fluorescence). An evaluation can be conducted to ascertain the method's effectiveness in preserving biological details and introducing a new evaluation metric, a weighted patch histogram (WPH), designed to capture the color histogram information from small patches of the image, thereby obtaining a spatially aware color histogram. Collectively, preserving cell-level information can demonstrate efficacy in presenting a promising advancement for the visualization and analysis of hPSC-derived cardiac organoid cell types and structures in biomedical research.

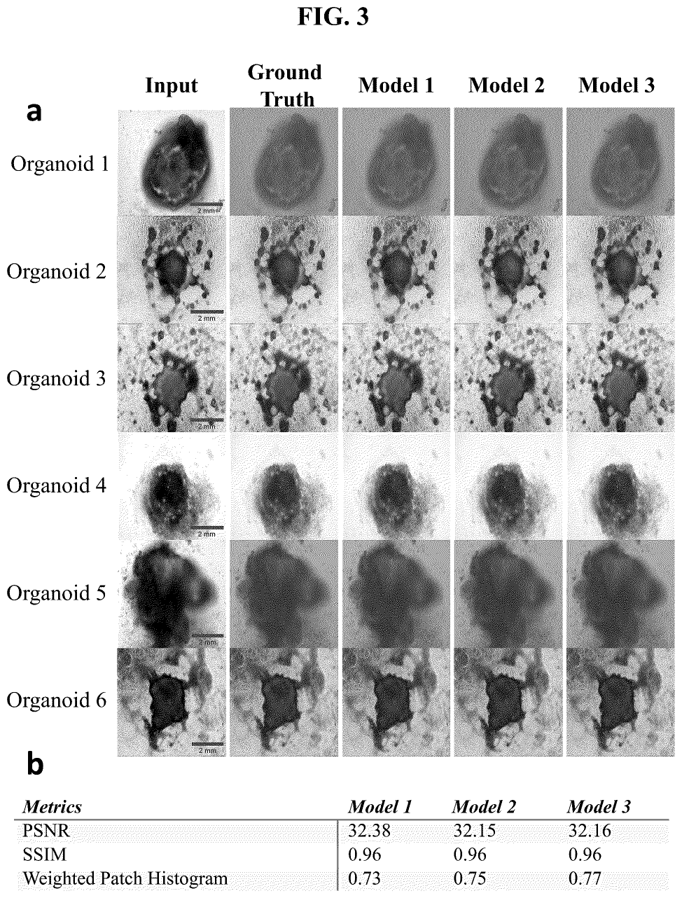

After hPSC-derived cardiac organoids are differentiated from the 3R triple-reporter hPSC line, the entire organoids with live-cell fluorescent microscopy can be imaged based on three fluorescence reporters: Green (G)-GFP-TNNT2-CM; Red (R)-mOrange-CDH5-EC; Blue (B)-CFP-TAGLN-SMC and phase contrast. The 3R hPSC-derived cardiac organoids on day 16 expressed green, red, and blue fluorescence in circular morphology as depicted in FIG. 3. To increase the diversified results of cardiac organoid differentiation, the organoids can be successfully differentiated into all three cell types (CM, EC, and SMC) and also the organoids composed of two cell types (CM and EC, or CM and SMC, or EC and SMC) and single cell type (CM or EC or SMC). Within the experimental setup, a portion of the total image can be used for training while reserving a sample set for testing and evaluation. To allow the model capture the intricate fluorescence details from a limited dataset, the majority of the data can be allocated for training. For example, greater than 90% of the data can be used for training. This approach aims to improve or maximize the model's exposure to diverse examples and the remaining subset of data can be used for testing and evaluation to assess the model's performance.

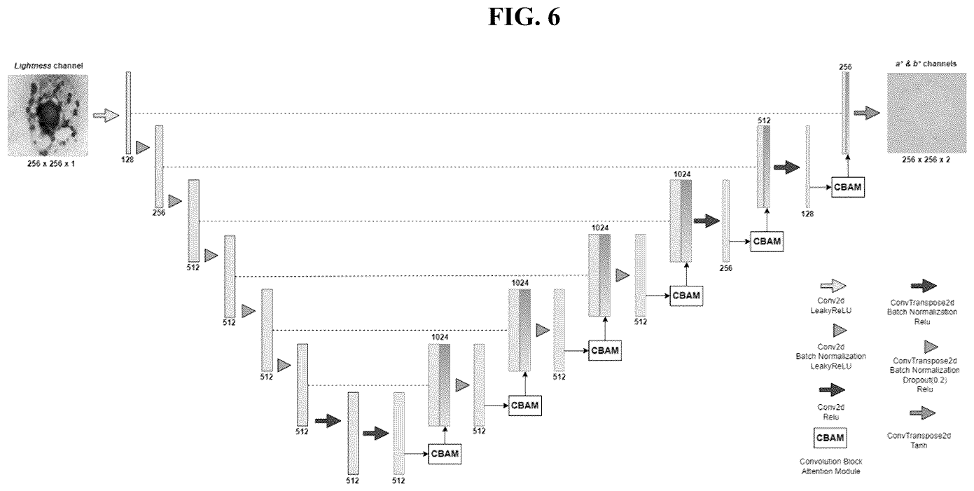

Three U-Net-based models can be designed for optimizing the image colorization of hPSC-derived cardiac organoids. As an example, the first model (e.g., Model 1), a U-Net generator only can be based on FIG. 6 without a CBAM block. Moreover, the second model (e.g. Model 2), U-Net generator with CBAM as depicted in FIG. 6 as well. Furthermore, the third model (e.g., Model 3), U-Net with CBAM and generator iteration can employ the architecture in Model 2 that can be trained twice in an epoch. With an intuition of making the generator stronger compared to the discriminator as it is trained multiple times to produce more realistic colors.

After three models are trained efficiently with the training dataset of paired phase contrast and fluorescence images from the same organoids, the three models can be applied for predicting the hPSC-derived cardiac organoid images in merged phase contrast and fluorescences of green, red, and blue channels as shown in FIG. 3a based on the phase contrast images of cardiac organoids. Those organoids used for image prediction and fluorescence colorization are not previously included in the training dataset but from the same batch of organoid differentiation. In some aspects, three evaluation metrics: the peak signal-to-noise ratio (PSNR), structural similarity index (SSIM), and WPH are employed to quantitatively evaluate the performance of the models. FIG. 3b depicts the outcome of evaluation scores achieved on those metrics. The images can then be passed to a patch discriminator to determine if the generated image is real or fake. In some embodiments, a patch discriminator, as further discussed below, can divide the image into N×N patches to produce the probability of a patch being real or fake and averaged the results of all patches to determine if the generated image is real or fake, unlike a regular discriminator that can use the whole image at once to make the prediction.

The range of PSNR is [0, ∞], where 0 represents no similarity between images and infinity is for the same images. For a comparison of lossy images, the PSNR score typically ranges between about 30 to about 50, about 40 to about 50, or about 45 to about 50, where the higher the score, the higher the similarity. Values over about 40, or even about 45 are usually considered to be very good and anything below about 20 is unacceptable. The well-established techniques achieved a PSNR score of 29.52 on the COCO-stuff dataset, whereas the models achieved PSNR scores are over 32. The COCO-stuff dataset platform is well-known for annotating images or using textual image descriptions by comparing the predicted images to the ground truth of COCO-Stuff at the pixel level. The structural similarity index (SSIM) score ranges in (1, 1) where −1 represents no similarity and 1 represents very high similarity. Therefore, a higher score indicates higher similarity. The state-of-the-art techniques have an SSIM score of 0.94 on the coco-stuff dataset, whereas the models achieved SSIM scores of 0.96. Weighted patch histogram (WPH) ranges in [0,1] where 0 represents no similarity in the histograms of the images, therefore no similarity, and 1 represents full similarity in histograms resulting in a very high similarity of the images. The similarity increases from about 0.73 to about 0.77 from Model 1 to Model 3.

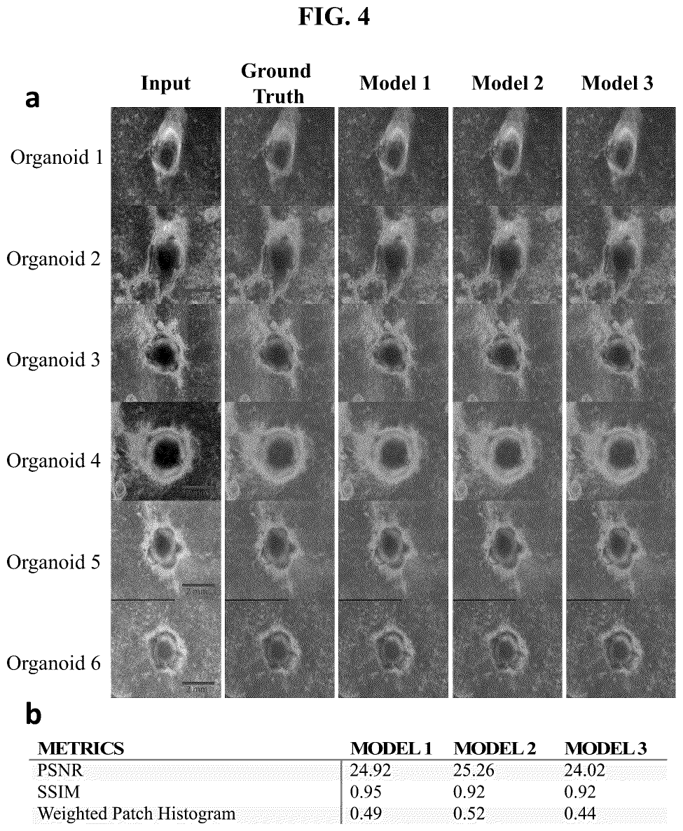

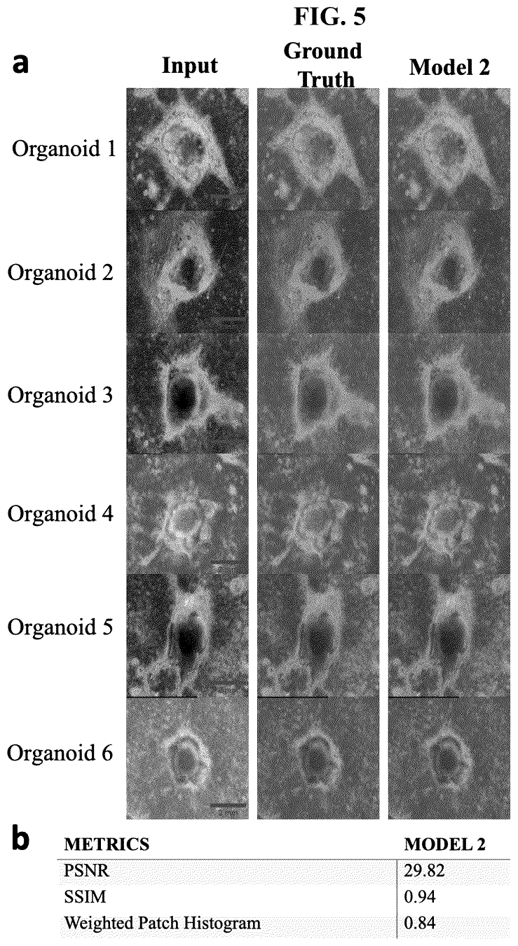

Because all three models provide good prediction results based on the similarity of the predicted image to the ground truth and evaluation metrics, the models are further applied to predict the organoids from different batches of organoid differentiation. As visualized in FIG. 4a and quantified in FIG. 4b, the predicted organoid images from Model 2 demonstrate the highest similarity in comparison to the other two Models with a higher PSNR (25.26 of Model 2 vs. 24.92 of Model 1 vs. 24.02 of Model 3) and weighted patch histogram (0.52 of Model 2 vs. 0.49 of Model 1 vs. 0.44 of Model 3). However, the results of evaluation metrics in FIG. 4b indicate that the scores decrease in terms of all the metrics in comparison to the prediction shown in FIG. 3b. Because Model 2 generates relatively better results than the other two models, model 2 is further fine-tuned by re-training Model 2 with one third of images from the new batches of organoid differentiation. After Model 2 is fine tuned, FIG. 5a shows the prediction results of the organoids from a new batch of differentiation. The color generation capability can be found of Model 2 increasing after fine-tuning with improved evaluation metrics of PSNR at 29.82, SSIM at 0.94, and WPH at 0.84 (FIG. 5b).

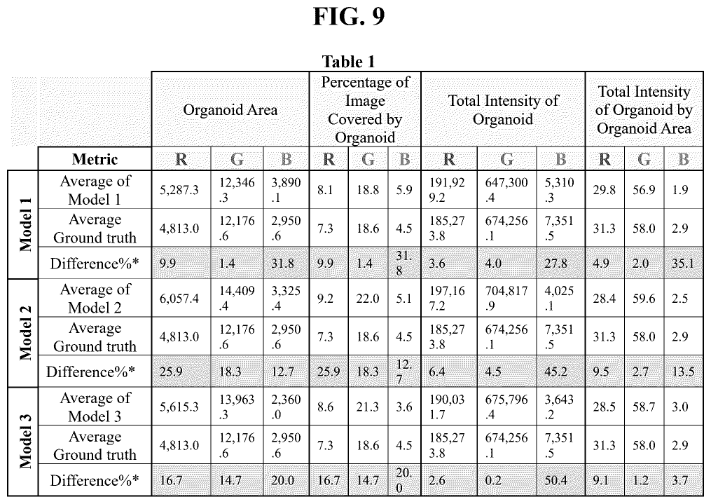

To further validate the predicted organoid images by analyzing and quantifying the fluorescence image of each color, which represents one type of cardiovascular cells (CM-green, EC-red, and SMC-blue). The single-channeled fluorescence images are quantified by software implementing the models described herein (e.g., Organalysis software, hereinafter “Organalysis”), which is an image processing software for cardiac organoid fluorescence images in high throughput recently developed by researchers at Syracuse University. Table 1 of FIG. 9 shows the average results of Organalysis-based analysis by comparing the generated images with different metrics like organoid area, percentage of image covered by organoid, total intensity of organoid, and total intensity of organoid-by-organoid area for 70 organoids that are used for the prediction of the same batch of organoid differentiation as shown in FIG. 3. The difference percent (%) compares the difference between the generated fluorescence and the ground truth of the same organoids, and difference percent lower than 25% are highlighted in green blocks and higher than 25% is highlighted in red blocks in Table 1 of FIG. 9. Accordingly, the fluorescence information from the red and green channels generated by Model 1 is close to the ground truth, but not the blue channel. The fluorescence measurements on the red, green, and blue channels generated by Model 2 are close to the ground truth with difference percent in lower or close to 25% in organoid area and percentage of image covered by organoid. Model 3 performed well showing low difference percent in all the metrics except for the total intensity of the organoid in the blue channel.

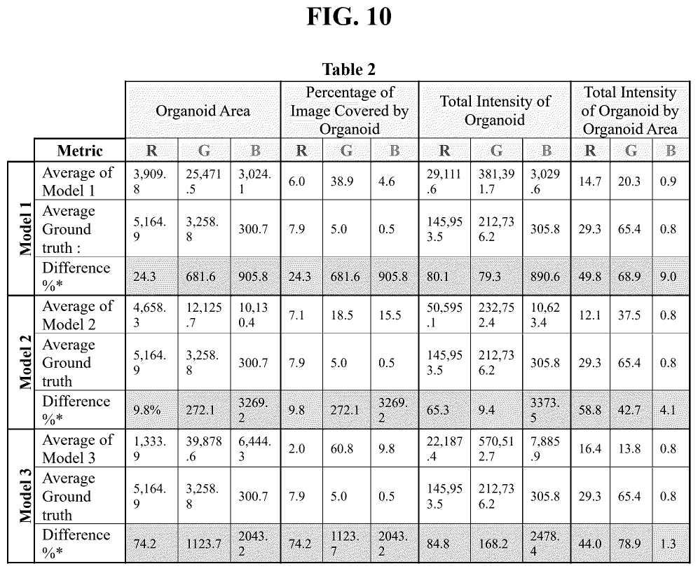

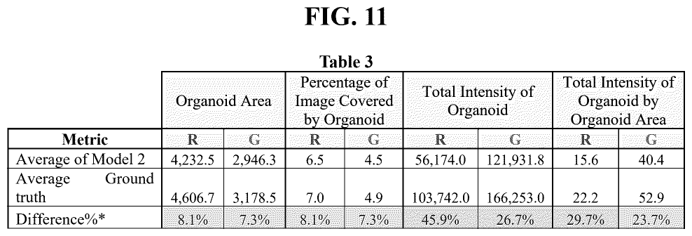

Moreover, the cGAN-generated fluorescence information of additional 25 cardiac organoids from a new batch of differentiation in FIG. 4a is further extracted and quantified by Organalysis. In Table 2 of FIG. 10, nearly all the models generated the fluorescence information for all three channels at high difference percent, which matches with the results of evaluation metrics in FIG. 4b. After fine tuning Model 2, Table 3 of FIG. 11 shows the results of Organalysis-based analysis by comparing the generated images with different metrics like organoid area, total image area, percentage of image covered by organoid, total intensity of organoid, total intensity of organoid-by-organoid area, and total intensity of organoid by total image area of the organoids in FIG. 5. The blue channel for SMC prediction is excluded further due to the inconsistency of the predicted results. The image of green fluorescence-labeled CMs in the cardiac organoids generated by the fine-tuned Model 2 is very close to the ground truth with less than a 16% difference to the ground truth in both organoid area and intensity in green fluorescence. The red fluorescence-labeled generated by the GAN model is also close to the ground truth ECs regarding the cardiac organoid area, however, the total intensity of generated red fluorescence is over 30% difference in comparison to the ground truth.

In some aspects, cardiac organoids being hPSC-derived are emerging as an in vitro human heart model, which has been used from basic developmental biology to translational drug discovery and regenerative medicine. However, how to characterize hPSC-derived cardiac organoids in high efficiency and efficacy at examining cardiovascular cell type-specific expression and networks without additional fluorescence immunostaining and imaging has not been achieved yet. Disclosed herein is a novel strategy for fluorescently colorizing cardiac organoids from phase contrast images by utilizing cGANs and CBAM. The findings illustrate the efficiency of this framework in capturing fluorescence intricacies of the cardiovascular cells (CMs, ECs, and SMCs) in the hPSC-derived cardiac organoids.

To better evaluate the prediction outcomes from the algorithms of cGANs and CBAM as disclosed herein, three different evaluation metrics can be applied with varied emphasis and focus on image recognition and comparison. For example, the WPH can be included as a new metric to highlight the efficacy of the approach in preserving biological details compared to traditional metrics like PSNR and SSIM. Typically, the images can be generated with evaluation scores of PSNR over 30, SSIM over 0.92, and a WPH score over 0.75 as the most accurate and similar to the ground truth.

Initially, the prediction of fluorescence images within the same batch of organoid differentiation is highly accurate, especially by integrating the CBAM into the conditional GAN framework of Model 2, which captured salient features in phase contrast cardiac organoid images with significant improvement. This attention mechanism can enhance the quality and fidelity of the generated colorizations by directing the model's focus toward critical regions within the image and generating realistic and accurate colorizations of grayscale organoid images. As a further test, the prediction outcome of organoids can be differentiated from different batches, and additional organoids from the other two new batches of organoid differentiation can be included. However, the prediction accuracy may be greatly reduced in PSNR and WPH. To address this problem and bolster the prediction accuracy of organoids from the different batches of differentiation, fine tuning can be accomplished by incorporating a portion (e.g., one half, one third, etc.) of organoid images from the new batches of differentiation into the training dataset. This step of fine turning can improve the prediction outcome with higher evaluation metrics.

Moreover, to accomplish organoid characterization in image quantification, the fluorescence image analysis and comparison can be conducted between prediction and ground truth. The most common measurement of organoid images can be adapted by focusing on cardiovascular-specific cell types: organoid area, percentage of image covered by organoid, total intensity of organoid, and total intensity of organoid-by-organoid area. The percentage of differences (difference %) in organoid area, percentage of image covered by organoid, total intensity of organoid, and total intensity of organoid-by-organoid area are all lower than 25% in the prediction of the same batches of organoids in G (GFP-CMs) and R (mOrange-ECs), however, the difference % of B (CFP-SMCs) in the total intensity of organoid is larger than 25% due to the insufficient dataset containing blue fluorescence information in hPSC-derived cardiac organoids. Moreover, the intensity of blue fluorescence is significantly lower than the other fluorescence channels making it highly sensitive in the quantification of blue fluorescence. Similar to the results of evaluation metrics, the difference percent in the organoid characterization measurement is more than 25% prior to the fine tuning. Through the optimization of fine tuning, the difference percent in green and red fluorescences becomes lower than 10% in the organoid area and percentage of image covered by organoid with significant improvement in the fluorescence colorization of hPSC-derived cardiac organoids, however, the prediction of fluorescence intensity-related measurements needs further improvements due to the variation of microscopic imaging at different days and batches even using the same imaging setup and parameters.

While the established cGAN and CBAM algorithm has achieved some level of predictions of hPSC-derived cardiac organoid fluorescence images from the corresponding phase contrast images, a few limitations can be addressed to improve the prediction accuracy with additional functions. For example, the prediction of blue-SMC fluorescence may be insufficient in both image visualization and quantification, and the cellular network prediction of green-CM and red-EC fluorescence can be improved. To overcome this limitation, the dataset size can be increased with more images at varied sample categories, such as including the cardiac organoids with varied and defined ratios of each fluorescence through controlled organoid differentiation. Also, employing ensemble learning techniques in some embodiments, where multiple models can be trained, and their predictions can be combined to improve overall accuracy and robustness. As supported by the results of fine tuning, the prediction accuracy can be enhanced significantly, however, how to achieve a promising prediction outcome without fine turning can be achievable. In some aspects, incorporating the progressive GAN technique in the training approach can enhance training stability and capture intricate details of hPSC-derived cardiac organoids possibly to skip the step of fine tuning, while achieving improved accuracy of fluorescence colorization. Accordingly, the predicted image quantification related to fluorescence intensity measurement can be improved further for the organoids from a new batch of differentiation. In some aspects, only epifluorescence images are included in the training dataset. In consideration of the three-dimensional (3D) structure of hPSC-derived cardiac organoids, the confocal fluorescence microscopic imaging with a 3D image stack can be considered to predict the 3D structure of organoids with cell-type specific expressions and networks. Lastly, the prediction of cardiac organoids differentiated from more hPSC lines can be included and evaluated to extend the application of this technology.

Image colorization of phase contrast or grayscale images of hPSC-derived cardiac organoids can use cGAN, specifically the Pix2Pix model. Image colorization of phase contrast or grayscale images of hPSC-derived cardiac organoids using cGAN, specifically the Pix2Pix model, can be utilized. In some aspects, the Pix2Pix conditional GAN methodology is used where the Pix2Pix model, short for “Pixel-to-Pixel Translation,” is a notable example of a cGAN. The CIELAB color space (hereinafter “CIELAB”) can consist of or comprise three channels, namely lightness, a*, and b*. In CIELAB, lightness can represent the grayscale channel, while a* and b* may represent the two-color channels. This lightness channel can serve as the conditional input to the generator, and the a* and b* channels may be the target channels for generating colorized versions of the grayscale images. In some aspects, the objective of using CIELAB color space is to extract only the color information from the cardiac organoid and train the model to generate the plausible colors of a* and b* merged on the grayscale input, to obtain the colorized cardiac organoid.

Additionally, CBAM may be incorporated to increase the channel and spatial attention of the GAN model to focus on the relevant features. CBAM is an innovative enhancement introduced to the architecture of deep neural networks, particularly CNNs. CBAM can integrate both channel and spatial attention mechanisms, facilitating the model's ability to focus on pertinent features within the input data. Channel attention can enable the network to adaptively assign importance to different channels, emphasizing relevant information while suppressing noise. Simultaneously, spatial attention ensures that the network allocates its focus to meaningful spatial regions within an image by, e.g., integrating CBAM into a conditional GAN framework to improve the model's ability to capture salient features in grayscale cardiac organoid images to enhance the quality and fidelity of the generated colorizations by directing the model's focus toward critical regions within the image.

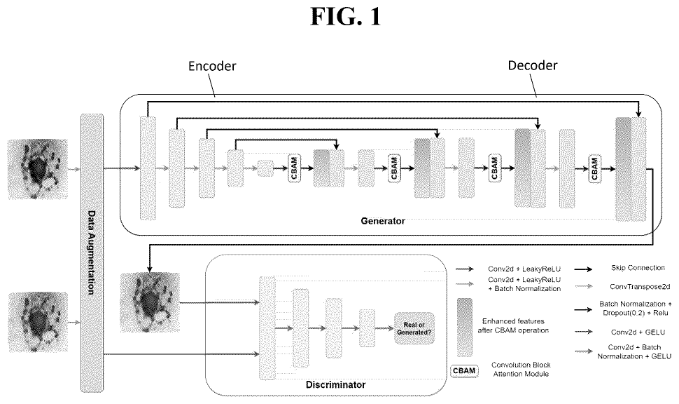

The primary motivation for incorporating conditional GANs, CIELAB color space, and CBAM is to increase the model's attention to relevant features and limit the model's predictions to only two channels (i.e., a* and b*), thereby reducing the number of predictions compared to the red (R), green (G), and blue (B) color space, where the model would have to make predictions for the RGB channels. The synergy between Pix2Pix, CIELAB, and CBAM contributes to notable colorization outcomes. FIG. 1 depicts the main components and steps of the process of the image colorization workflow, which depicts the transformation of a grayscale cardiac organoid image to a fully colorized output using Pix2Pix conditional GAN. The conditional input passed to the generator is the lightness channel and the discriminator can be trained on the a* and b* channels.

The U-Net generator can consist of or comprise an encoder and a decoder, connected by a bottleneck layer. FIG. 1 demonstrates the architecture of the U-Net generator where the encoder progressively reduces the spatial dimensions of the input grayscale image while extracting features. The decoder then upsamples these features to produce the final colorized output. Skip connections between corresponding encoder and decoder layers facilitate the flow of low-level features, enhancing the network's ability to capture fine details.

In some aspects, one distinctive feature of the U-Net generator is utilization of the lightness (L) channel from the CIELAB color space as a conditional input. This L channel represents the grayscale information of the input image. By incorporating this channel, the generator can focus on producing color information (a* and b* channels) that is coherent with the grayscale content.

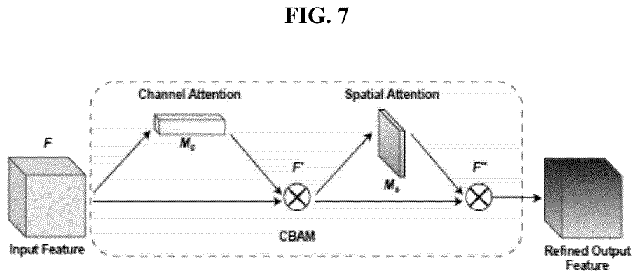

Generally, the generator's ability can be enhanced using the CBAM, which integrates channel and spatial attention mechanisms, can enable the discriminator to adaptively assign importance to different channels and meaningful spatial regions within the image. In some aspects, CBAM as shown in FIGS. 6-7 is an integral component incorporated into the U-Net generator architecture to enhance its ability to capture and emphasize relevant features within grayscale organoid images. An overview of the U-Net generator's architecture is depicted in FIG. 6. The U-Net generator derives its name from its characteristic U-shaped architecture. An exemplary CBAM is depicted in FIG. 7. The input feature map is F∈R^{C×H×W} and CBAM extracts 1D channel attention map M_{c}∈R^{C×1×1} and a 2D spatial attention map Mₛ∈R^{1×H×W}. In some embodiments, the overall attention processes can be defined by the following equation:

$${F}^{′} = {M}_{c} ( F ) ⊗ F , {F}^{″} = {M}_{s} ( {F}^{′} ) ⊗ {F}^{′} \qquad ( 1 )$$

where ⊗ denotes the element-wise multiplication and the resulting F″ is the final refined output map that includes the details from both channel attention and spatial attention. This operation allows the model to focus on relevant features while suppressing irrelevant information.

In some aspects, channel attention enables the network to adaptively assign importance to different channels of feature maps, emphasizing relevant information while suppressing noise. In some aspects, channel attention can be used when dealing with multi-channel images, such as the L*a*b* color space. This selective channel weighting can allow the model to focus on the pertinent informative colorization components.

In some aspects, spatial attention is another aspect of CBAM to ensure that the network allocates its focus to meaningful spatial regions within an image. In the context of colorization, the model can be guided to concentrate on the relevant regions where colorization details are pertinent. In some embodiments, spatial attention complements channel attention by pinpointing targeted areas in the input. In some aspects, an attention layer or mechanism can enhance the quality and fidelity of the generated colorizations by directing the model's focus toward critical regions within the image and generating realistic and accurate colorizations of grayscale organoid images.

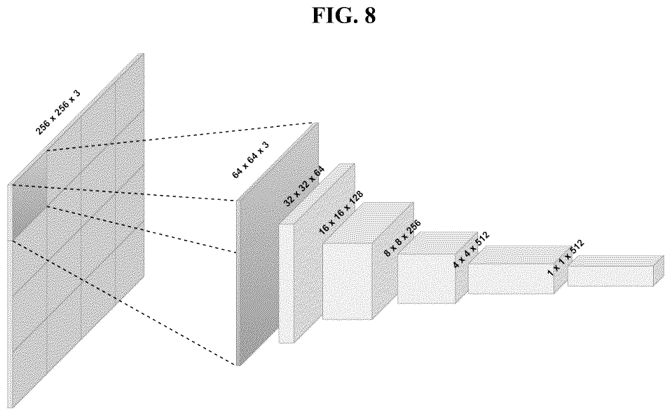

The patch discriminator is a CNN designed to operate on image patches rather than entire images. An exemplary patch discriminator for some embodiments is shown in FIG. 8. This approach can allow the discriminator to focus on local details and textures, being well-suited for assessing the quality of colorizations at a fine-grained level, and can consist of or comprise multiple convolutional layers to produce a single feature map that is used to classify the patch as real or fake. The final classification may result for the entire image obtained by averaging the predictions from patches across the entire image. The result can be a global classification score that represents the discriminator's assessment of the overall image.

The patch discriminator can engage in adversarial training with the U-Net generator, and may aim to distinguish between real colorized organoid patches and fake patches generated by the generator. In some aspects, through this adversarial process, the discriminator can provide feedback to the generator, encouraging the generator to produce colorizations that are indistinguishable from real color images.

The primary objective of the patch discriminator can guide the U-Net generator in generating high-quality colorizations. Assessing the local realism of colorized patches can ensure that fine-grained details and textures are faithfully preserved in the output.

The discriminator, a key component of the conditional GAN, serves the crucial role of assessing the authenticity of colorized organoid images to determine a discriminator loss. In some aspects, to fulfill this role, the binary cross-entropy loss (BCEWithLogitsLoss) is used.

Mathematically, the discriminator loss can be expressed as:

$${ℒ}_{𝒟} = - \frac{1}{N} {\sum }_{i = 1}^{N} [ {y}_{i} \cdot log ( D ( {x}_{i} ) ) + ( 1 - {y}_{i} ) \cdot log ( 1 - D ( G ( {L}_{i} ) ) ) ] \qquad ( 2 )$$

Here, [symbol] represents the discriminator loss, where N is the batch size, x_i denotes the ground truth colorized organoid images, yᵢ represents labels for real images (yᵢ=1) and fake images ((yᵢ=0), D(xᵢ)) signifies the discriminator's output for real images, and G(Lᵢ) signifies the generator's output for the corresponding grayscale input (Lᵢ). The BCEWithLogitsLoss computes the binary cross-entropy loss by comparing the discriminator's predictions with the ground truth labels.

The discriminator aims to maximize this loss, which encourages it to correctly classify real and fake patches within the images. Simultaneously, the generator minimizes this loss during adversarial training to produce colorizations that are indistinguishable from real images.

The generator, a component of the conditional GAN, is tasked with generating plausible colorizations using generator loss. To achieve this, a combination of two loss functions: binary cross-entropy loss (BCEWithLogitsLoss) and L1 Loss (mean absolute error), can be used. Similar to the discriminator, BCEWithLogitsLoss as its adversarial loss function may be used. It encourages the generator to produce colorizations that convincingly fool the discriminator into classifying them as real.

Mathematically, the generator's adversarial loss is defined as:

$${ℒ}_{{𝒢}_{𝒢𝒜𝒩}} = - \frac{1}{N} {\sum }_{i = 1}^{N} log ( D ( G ( {L}_{i} ) ) ) \qquad ( 3 )$$

This loss drives the generator to produce colorizations that are perceptually similar to real color images.

In addition to the adversarial loss, the L1 Loss can be incorporated to ensure that the generated colorizations closely match the ground truth images in terms of pixel-wise similarity as L1 Loss (mean absolute error).

Mathematically, the generator's L1 loss is expressed as:

$${ℒ}_{{𝒢}_{ℒ 1}} = \frac{1}{N} {\sum }_{i = 1}^{N} {\vert G ( {L}_{i} ) - {C}_{i} \vert}_{1} \qquad ( 4 )$$

Here, L_{G}_{_{L1}} represents the generator's L1 loss, where N is the batch size, Lᵢ denotes the grayscale input images, G(Lᵢ) represents the generator's colorized output, and Cᵢ denotes the corresponding ground truth color images. The L1 loss encourages the generator to produce colorizations that closely match the ground truth, focusing on fine-grained pixel-level details.

By combining these two loss components, the generator is trained to produce colorized organoid images that are both visually convincing and pixel-wise accurate, ultimately enhancing the quality and realism of the generated colorizations.

Evaluating the accuracy and quality of the generated image can a challenging task with a limited dataset of 1300 images so non-deep-learning metrics are employed to obtain a similarity score. In some embodiments, three different evaluation metrics are used to PSNR, SSIM, and WPH to compare the similarity between ground truth and colorized images.

PSNR can be used to measure the quality of reconstructed or compressed images and this metric is used for comparing the similarity of the colorized image with ground truth. It objectively measures how well a colorization technique preserves the details and visual fidelity of the original image. By calculating the PSNR value, the accuracy and fidelity of colorization algorithms can be evaluated. In some aspects, the range is (0, ∞), where 0 represents no similarity between images, and the higher the score, the higher the similarity.

PSNR score of an m×n (width×height) image I and its compressed image K can be determined by:

$$20 \cdot {log}_{10} ( {MAX}_{I} ) - 10 \cdot {log}_{10} ( M S E ) \qquad ( 5 )$$

where MAX_{I} is the maximum possible pixel value of the image and MSE is the mean square error of the original image I and its compressed image K can be calculated by:

$$\frac{1}{m n} {\sum }_{i = 0}^{m - 1} {{\sum }_{j = 0}^{n - 1} [ I ( i , j ) - K ( i , j ) ]}^{2} \qquad ( 6 )$$

The SSIM is a widely used evaluation metric for assessing the visual quality of the colorized image with ground truth. It considers global and local image characteristics, capturing the perceptual differences and structural similarities between the colorized and ground truth images. To be specific, SSIM compares three components in an image pair, suppose x and y are the two patches of the true and compressed image respectively that are aligned with each other, the luminescence comparison function l(x,y) captures the differences in brightness, the contrast comparison function c(x,y) accesses variation in image contrast and the structure comparison function s(x,y) measures differences in image structure and texture. SSIM is a combination of all these three factors:

$$SSIM ( x , y ) = [ l ( x , y ) \cdot c ( x , y ) \cdot s ( x , y ) ] \qquad ( 7 )$$

By evaluating the preservation of underlying structures and textures, SSIM provides a comprehensive measure of the algorithm's ability to maintain visual coherence and realism. The SSIM score typically falls within the range of (−1, 1)²⁵, where a higher score signifies greater similarity.

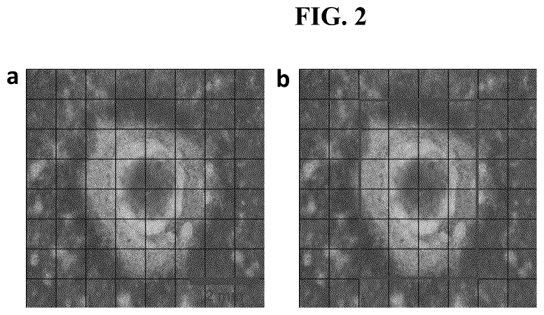

PSNR and SSIM are widely used metrics in evaluating image colorization tasks. Still, they are not exactly appropriate for the problem, because PSNR is designed to identify the quality of the compressed image with the original image. Similarly, SSIM primarily focuses on structural similarity rather than color which is the main part of image colorization. So, WPH can be tested to compare the similarity of generated colors. With regular histogram comparison, valuable spatial information of the color is lost, so in the approach, the image can be split into a 16×16 grid, as depicted in FIG. 2a, to have multiple small patches of the image and compare these small patches individually to the corresponding patch from the ground truth. This patch histogram comparison increased the spatial information of the pixel's value.

In some embodiments, as patch histogram comparison increases spatial color information, therefore, reducing the patch size to the smallest possible value may produce the best results. Generally, the smallest size possible to compare is 1×1 pixels, which leads to a pixel-to-pixel comparison of the images that can be highly sensitive to noise and unreliable. So, the optimized balance between the patch size and the number of bins in the histogram comparison can be tested and validated, and a patch size of 32×32 pixels and 32 bins can be ideal for histogram comparison in cardiac organoid images. Usually most of the cardiac organoids are centered in the image and are the region of interest (ROI), which provides enhanced significance in color comparison without the excessive background. The weightage for the patches inside the ROI in FIG. 2b may be increased by 50% to give more importance to the colors in the organoids. In some embodiments, a weighted patch histogram can compare the similarity of generated colors, as discussed above.

According to the recently published organoid image pre-processing and analysis platform-organalysis, the organoid area, percentage of image covered by organoid, total intensity of organoid, and total intensity of organoid-by-organoid area are quantified from the predicted images and paired ground truth of each organoid with the following measurements:

### Organoid Area: Total Pixel Numbers of Fluorescence Per Cell Type in Each Organoid

$$Percentage of Organoid Coverage = \frac{Total Area of Organoid}{Total Area of Image} \\ Total Intensity of Organoid by Organoid Area = \frac{Total Intensity of Organoid}{Pixel Area of Organoid} \\ Total Intensity o f Organoid by Total Image Area = \frac{Total Intensity of Organoid}{Total Area of Image} \\ Difference between predicted image and ground truth percent = \frac{M e a s u r ement of predicted image - m e a s u r ement of ground truth}{M e a s u r ement of ground truth} 100 \%$$

Thus, a novel model can establish challenges of colorizing phase images of hPSC-derived cardiac organoids using cGANs and CBAM. This framework has demonstrated its efficacy in capturing intricate multichannel fluorescence information within the hPSC-derived cardiac organoids, enhancing the interpretability and analysis of cardiovascular cell type and biomarker expression in both images and quantification for biomedical research and applications. The cGAN model, enriched by the CBAM module, outperformed the other two models, showcasing its adaptability and effectiveness by evaluating and comparing three evaluation metrics. In some aspects, optimal results on the organoid from new batches of differentiation can be obtained by fine tuning the model, ensuring that accurate and faithful fluorescence information is generated. Moreover, the quantification of fluorescence information can predict organoid images to bring extensive validation of hPSC-derived cardiac organoids for broader and impactful biomedical applications, such as the prediction of cell type-specific drug cardiotoxicity, prediction of cardiovascular development, sex, race, and genetic and/or mutation-specific disease evaluations, if more diverse hPSC cell lines are included in the training dataset. A similar algorithm or strategy can also be applied to the brain, liver, kidney, and cancer organoids for automatic fluorescence colorization and quantification. The system may also find use for organs for automatic fluorescence colorization and quantification.

Having described various systems and methods herein, certain embodiments can include, but are not limited to:

In an aspect, a method for generating colorized organoid images comprises synthesizing, by a generator, an input feature map from a grayscale image derived from a lightness channel as a conditional input; extracting, by a convolution block attention layer (CBAL), a 1D channel attention map and a 2D spatial attention map derived from the input feature map; generating, by the CBAL, a refined output feature map derived from the 1D channel attention map and the 2D spatial attention map; synthesizing, by the generator, color information derived from the lightness channel and the refined output feature map, wherein the color information comprises an a* channel and a b* channel; calculating, by a discriminator based on at least the lightness channel and the color information, a value indicating a probability that the color information is real; and performing the aforementioned steps iteratively until the generator produces the color information which the discriminators can no longer identify as fake.

A second aspect can comprise the method for generating colorized organoid images of the first aspect, wherein the generator comprises a U-net generator.

A third aspect can comprise the method for generating colorized organoid images of the first aspect or the second aspect, wherein the CBAL is integrated within the generator.

A fourth aspect can comprise the method for generating colorized organoid images of any one of the proceeding aspects, wherein the generator comprises an encoder and a decoder, wherein the method further comprises reducing with the encoder a spatial dimension of the grayscale image while extracting features; and upsampling with the decoder the extracted features to synthesize the color information.

A fifth aspect can comprise the method for generating colorized organoid images of any one of the proceeding aspects, wherein the encoder and the decoder are connected by a bottleneck layer.

A sixth aspect can comprise the method for generating colorized organoid images of any one of the proceeding aspects, wherein the color information is coherent with the lightness channel.

A seventh aspect can comprise the method for generating colorized organoid images of any one of the proceeding aspects, wherein the discriminator is a convolutional neural network.

An eighth aspect can comprise the method for generating colorized organoid images of any one of the proceeding aspects, wherein the grayscale image is a cardiac organoid image.

A ninth aspect can comprise the method for generating colorized organoid images of any one of the proceeding aspects, further comprising evaluating the color information with a weighted patch histogram.

A tenth aspect can comprise the method for generating colorized organoid images of any one of the proceeding aspects, further comprising calculating patches, by a patch discriminator to distinguish between real colorized organoid patches and fake patches by the generator.

An eleventh aspect can comprise the method for generating colorized organoid images of any one of the proceeding aspects, further comprising calculating patches, by a patch discriminator to distinguish between real colorized organoid patches and fake patches by the U-net generator.

A twelfth aspect can comprise the method for generating colorized organoid images of any one of the proceeding aspects, further comprising calculating a discriminator loss.

A thirteenth aspect can comprise the method for generating colorized organoid images of any one of the proceeding aspects, wherein the discriminator loss is calculated by the following formula:

$${ℒ}_{𝒟} = - \frac{1}{N} {\sum }_{i = 1}^{N} [ {y}_{i} \cdot log ( D ( {x}_{i} ) ) + ( 1 - {y}_{i} ) \cdot log ( 1 - D ( G ( {L}_{i} ) ) ) ]$$

wherein [symbol] represents the discriminator loss, where N is a batch size, xᵢ denotes ground truth colorized organoid images, yᵢ represents labels for real images (yᵢ=1) and fake images ((yᵢ=0), D(xᵢ)) signifies a discriminator's output for real images, and G(Lᵢ) signifies a generator's output for a corresponding grayscale input (Lᵢ).

A fourteenth aspect can comprise the method for generating colorized organoid images of any one of the proceeding aspects, further comprising calculating a discriminator loss.

A fifteenth aspect can comprise the method for generating colorized organoid images of any one of the proceeding aspects, wherein the discriminator maximizes the discriminator loss to correctly classify real and fake patches within images.

A sixteenth aspect can comprise the method for generating colorized organoid images of any one of the proceeding aspects, further comprising evaluating accuracy and quality of a generated image by using at least one evaluation metric of PSNR, SSIM, WPH, or a combination thereof.

In a seventeenth aspect, a method for generating colorized organoid images comprises: synthesizing, by a patch generator, an input feature map from a grayscale image derived from a lightness channel as a conditional input; extracting, by a convolution block attention layer (CBAL), one or more patches of a 1D channel attention map and a 2D spatial attention map derived from the input feature map; generating, by the CBAL, the one or more patches of a refined output feature map derived from the 1D channel attention map and the 2D spatial attention map; synthesizing, by the generator, the one or more patches of color information derived from the lightness channel and the refined output feature map, wherein the color information comprises an a* channel and a b* channel; calculating, by a discriminator based on at least the lightness channel and the color information, a value indicating a probability that the color information is real; and the generator and the discriminator performing the aforementioned steps iteratively until the generator produces the color information which the discriminators can no longer identify as fake for the one or more patches.

An eighteenth aspect can comprise the method for generating colorized organoid images of the seventeenth aspect, further comprising calculating a discriminator loss.

A nineteenth aspect can comprise the method for generating colorized organoid images of the seventeenth aspect or the eighteenth aspect, wherein the discriminator loss is calculated by the following formula:

$${ℒ}_{𝒟} = - \frac{1}{N} {\sum }_{i = 1}^{N} [ {y}_{i} \cdot log ( D ( {x}_{i} ) ) + ( 1 - {y}_{i} ) \cdot log ( 1 - D ( G ( {L}_{i} ) ) ) ]$$

wherein: [symbol] represents the discriminator loss, where N is a batch size, xᵢ denotes ground truth colorized organoid images, yᵢ represents labels for real images (yᵢ=1) and fake images ((yᵢ=0), D(xᵢ)) signifies the discriminator's output for real images, and G(Lᵢ) signifies a generator's output for a corresponding grayscale input (Lᵢ).

A twentieth aspect can comprise the method for generating colorized organoid images of any of the seventeenth aspect to the nineteenth aspect, wherein the discriminator maximizes the discriminator loss to correctly classify real and fake patches within images.

A twenty-first aspect can comprise the method for generating colorized organoid images of any of the seventeenth aspect to the twentieth aspect, further comprising evaluating accuracy and quality of a generated image by using at least one evaluation metric of PSNR, SSIM, WPH, or a combination thereof.

A twenty-second aspect can comprise the method for generating colorized organoid images of any of the seventeenth aspect to the twenty-first aspect, wherein the discriminator is a convolutional neural network.

A twenty-third aspect can comprise the method for generating colorized organoid images of any of the seventeenth aspect to the twenty-second aspect, further comprising calculating a generator loss to produce colorizations to convincingly fool the discriminator into classifying them as real.

A twenty-fourth aspect can comprise the method for generating colorized organoid images of any of the seventeenth aspect to the twenty-third aspect, wherein the generator loss comprises a binary cross-entropy loss and an L1 loss.

In a twenty-fifth aspect, a system for capturing fluorescence intricacies of cardiovascular cells (CMs, ECs, and SMCs) in hPSC-derived cardiac organoids, comprises: a generator for synthesizing an input feature map from a grayscale image derived from a lightness channel as a conditional input; a convolution block attention layer (CBAL) for extracting a 1D channel attention map and a 2D spatial attention map derived from the input feature map, and generating a refined output feature map derived from the 1D channel attention map and the 2D spatial attention map; the generator for synthesizing by color information derived from the lightness channel and the refined output feature map, wherein the color information comprises an a* channel and a b* channel; a discriminator calculating based on at least the lightness channel and the color information, a value indicating a probability that the color information is real; and the generator and the discriminator performing the aforementioned steps iteratively until the generator produces the color information which the discriminators can no longer identify as fake.

For purposes of the disclosure herein, the term “comprising” includes “consisting” or “consisting essentially of.” Further, for purposes of the disclosure herein, the term “including” includes “comprising,” “consisting,” or “consisting essentially of.”

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the embodiments of the present invention. The discussion of a reference in the Description of Related Art is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

While embodiments of the invention have been shown and described, modifications thereof can be made by one skilled in the art without departing from the spirit and teachings of the invention. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

What is claimed is:

1. A method for generating colorized organoid images, the method comprising:
synthesizing, by a generator, an input feature map from a grayscale image derived from a lightness channel as a conditional input;
extracting, by a convolution block attention layer (CBAL), a 1D channel attention map and a 2D spatial attention map derived from the input feature map;
generating, by the CBAL, a refined output feature map derived from the 1D channel attention map and the 2D spatial attention map;
synthesizing, by the generator, color information derived from the lightness channel and the refined output feature map, wherein the color information comprises an a* channel and a b* channel;
calculating, by a discriminator based on at least the lightness channel and the color information, a value indicating a probability that the color information is real; and
performing the aforementioned steps iteratively until the generator produces the color information which the discriminators can no longer identify as fake.

2. The method of claim 1, wherein the generator comprises a U-net generator.

3. The method of claim 1, wherein the CBAL is integrated within the generator.

4. The method of claim 1, wherein the generator comprises an encoder and a decoder, wherein the method further comprises:
reducing with the encoder a spatial dimension of the grayscale image while extracting features; and
upsampling with the decoder the extracted features to synthesize the color information.

5. The method of claim 4, wherein the encoder and the decoder are connected by a bottleneck layer.

6. The method of claim 1, wherein the color information is coherent with the lightness channel.

7. The method of claim 1, wherein the discriminator is a convolutional neural network.

8. The method of claim 1, wherein the grayscale image is a cardiac organoid image.

9. The method of claim 1, further comprising evaluating the color information with a weighted patch histogram.

10. The method of claim 1, further comprising calculating patches, by a patch discriminator to distinguish between real colorized organoid patches and fake patches by the generator.

11. The method of claim 2, further comprising calculating patches, by a patch discriminator to distinguish between real colorized organoid patches and fake patches by the U-net generator.

12. The method of claim 11, further comprising calculating a discriminator loss.

13. The method of claim 12, wherein the discriminator maximizes the discriminator loss to correctly classify real and fake patches within images.

14. The method of claim 1, further comprising evaluating accuracy and quality of a generated image by using at least one evaluation metric of PSNR, SSIM, WPH, or a combination thereof.

15. A method for generating colorized organoid images, the method comprising:
synthesizing, by a patch generator, an input feature map from a grayscale image derived from a lightness channel as a conditional input;
extracting, by a convolution block attention layer (CBAL), one or more patches of a 1D channel attention map and a 2D spatial attention map derived from the input feature map;
generating, by the CBAL, the one or more patches of a refined output feature map derived from the 1D channel attention map and the 2D spatial attention map;
synthesizing, by the generator, the one or more patches of color information derived from the lightness channel and the refined output feature map, wherein the color information comprises an a* channel and a b* channel;
calculating, by a discriminator based on at least the lightness channel and the color information, a value indicating a probability that the color information is real; and
the generator and the discriminator performing the aforementioned steps iteratively until the generator produces the color information which the discriminators can no longer identify as fake for the one or more patches.

16. The method of claim 15, further comprising evaluating accuracy and quality of a generated image by using at least one evaluation metric of PSNR, SSIM, WPH, or a combination thereof.

17. The method of claim 15, wherein the discriminator is a convolutional neural network.

18. The method of claim 15, further comprising calculating a generator loss to produce colorizations to convincingly fool the discriminator into classifying them as real.

19. The method of claim 18, wherein the generator loss comprises a binary cross-entropy loss and an L1 loss.

20. A system for capturing fluorescence intricacies of cardiovascular cells (CMs, ECs, and SMCs) in hPSC-derived cardiac organoids, comprising:
a generator for synthesizing an input feature map from a grayscale image derived from lightness channel as a conditional input;
a convolution block attention layer (CBAL) for extracting a 1D channel attention map and 2D spatial attention map derived from the input feature map, and generating a refined output feature map derived from the 1D channel attention map and the 2D spatial attention map;
the generator for synthesizing by color information derived from the lightness channel and;
the refined output feature map, wherein the color information comprises an a* channel and a b* channel;
a discriminator calculating based on at least the lightness channel and the color information, a value indicating a probability that the color information is real; and
the generator and the discriminator performing the aforementioned steps iteratively until the generator produces the color information which the discriminators can no longer identify as fake.
